(19) United States
(12) Patent Application Publication
(10) Pub. No.: US 2017/0031925 A1
(43) Pub. Date: Feb. 2, 2017

(54) MAPPING DYNAMIC SPACES AND WAY FINDING RELATED TO THE MAPPING

(71) Applicant: Cisco Technology, Inc., San Jose, CA (US)

(72) Inventors: Pradeep Kumar Mishra, Bangalore (IN); Giridhar Govindarajulu, Bangalore (IN); Plamen Nedeltchev, San Jose, CA (US); Manuel Goulart Garcia, San Jose, CA (US); Francisco Xavier España Mendes de Oliveira, Mountain View, CA (US)

(21) Appl. No.: 15/054,744

(22) Filed: Feb. 26, 2016

Related U.S. Application Data
(60) Provisional application No. 62/197,254, filed on Jul. 27, 2015.

(51) Int. Cl. G06F 17/30; G06T 11/60; G06T 11/20

(52) U.S. Cl. CPC G06F 17/30061; G06F 17/30345; G06F 17/3056; G06T 11/20; G06T 11/60

(57) ABSTRACT

A client receives map objects that define respective physical objects of a floor plan of a building, including a floor plan outer boundary, one or more rooms, and connected pathways traversable by a person. The client renders, in scalable vector graphic form, the map objects into a map of the floor plan that depicts the respective physical objects, including the one or more rooms, the connected pathways, and the outer boundary. The client displays the map. The client receives an update message that defines a change to the floor plan with respect to a map object identified in the update message, and renders the change with respect to the identified map object into the map to depict the change on the map without rendering any other ones of the map objects that were previously rendered into the map. The client displays the map with the change depicted on the map.

### CROSS REFERENCE TO RELATED APPLICATION

This application claims priority to U.S. Provisional Application No. 62/197,254 filed Jul. 27, 2015, the entirety of which is incorporated herein by reference.

### TECHNICAL FIELD

The present disclosure relates to mapping of dynamic spaces, such as building floor plans.

### BACKGROUND

Spatial mapping technology has become ubiquitous for outdoor maps; however, few alternatives exist for indoor mapping solutions. Conventional mapping solutions include image overlays on top of existing world mapping solutions meant to display a Mercator projection on a Cartesian system and do not have the granularity needed to route to a location. Thus, a map of a floor plan is relegated to a set of overlay pixels being placed on an existing mapping solution. Such solutions cannot be quickly and dynamically updated to reflect current conditions, including new or mobile assets. Therefore, way finding (i.e., determining and mapping routes from a first location to a second location) with conventional solutions use presumed, instead of actual, spatial mapping which may present a problem when a user attempts to navigate in previously unknown locations, or when autonomous devices, e.g., robots, mobile telepresence units, or other autonomous devices, are being driven or navigated over non-dynamically mapped spatial environments.

### BRIEF DESCRIPTION OF THE DRAWINGS

FIG. 1 is a block diagram of an environment in which embodiments directed to mapping of dynamic floor plans may be implemented, according to an example embodiment.

FIG. 2 is a flowchart of an example method of generating map entries in a spatial database performed by a server device of FIG. 1, according to an example embodiment.

FIG. 3 is an illustration of a generalized format of a vector graphics renderable map object stored in the spatial database, according to an example embodiment.

FIG. 4 is an illustration of a generalized format of a map object update stored in the spatial database, according to an example embodiment.

FIGS. 5A and 5B are a collection of map objects that collectively define a map of a floor plan and that may each be rendered individually and independent of each other into a graphic on the map, according to an example embodiment.

FIG. 6 is a collection of map object updates that represent changes to a floor plan defined by the collection of map objects of FIG. 5, according to an example embodiment.

FIG. 7 is a flowchart of an example method of mapping a dynamic floor plan performed by the server device, according to an example embodiment.

FIG. 8 is a flowchart of a method of mapping a dynamic floor plan performed by a client device of FIG. 1 and corresponding to the method of FIG. 7, according to an example embodiment.

FIG. 9 is an illustration of a partially rendered floor plan map corresponding to an actual (i.e., real-view) floor plan shown in FIG. 1 and that may be displayed by the client device in the method of FIG. 8, according to an example embodiment.

FIG. 10 is an illustration of a fully rendered floor plan map corresponding to the actual floor plan and that may be displayed by the client device in the method of FIG. 8, according to an example embodiment.

FIG. 11 is a flowchart of a method of way finding based on a previously rendered and displayed floor plan map performed by/on the client device, according to an example embodiment.

FIG. 12 is an illustration of a floor plan map of the floor plan of FIG. 1 created by the client device in the method of FIG. 11 and that shows a shortest path between end and start locations on the map, according to an embodiment.

FIG. 13 is an illustration of the floor plan map of FIG. 12, but that shows a current location of the client device on the map as the client device moves along the shortest path, according to an example embodiment.

FIG. 14 is an illustration of the floor plan map of FIGS. 12 and 13 that shows a new shortest path between the current location on the map and a new end location on the map, according to an example embodiment.

FIG. 15 is a block diagram of a computer system representative of either the server device or the client device.

### DESCRIPTION OF EXAMPLE EMBODIMENTS

### Overview

Map objects are received at a client device. The map objects define respective physical objects of a floor plan of a building, including a floor plan outer boundary, one or more rooms, and connected pathways traversable by a person. The map objects are rendered, in scalable vector graphic form, into a map of the floor plan that depicts the respective physical objects, including the one or more rooms, the connected pathways, and the outer boundary. The map is displayed. An update message is received that defines a change to the floor plan with respect to a map object identified in the update message. The change is rendered with respect to the identified map object into the map to depict the change on the map without rendering any other ones of the map objects that were previously rendered into the map. The map is displayed with the change depicted on the map.

At a server device, information for collections of map objects is stored. The collections correspond to floor plans. Each collection of map objects includes map objects defining respective physical objects of the corresponding floor plan, including a floor plan outer boundary, rooms, connected pathways traversable by a person, and movable objects, each map object defining a location for the respective physical object on the corresponding floor plan. At the server, information identifying one of the floor plans is received. The collection of map objects corresponding to the identified floor plan is retrieved and transmitted to a client device after a communication link with the client device has been established. A determination is made that a change to the floor plan has occurred. An update message indicating the change to the floor plan is transmitted to the client device.

### Example Embodiments

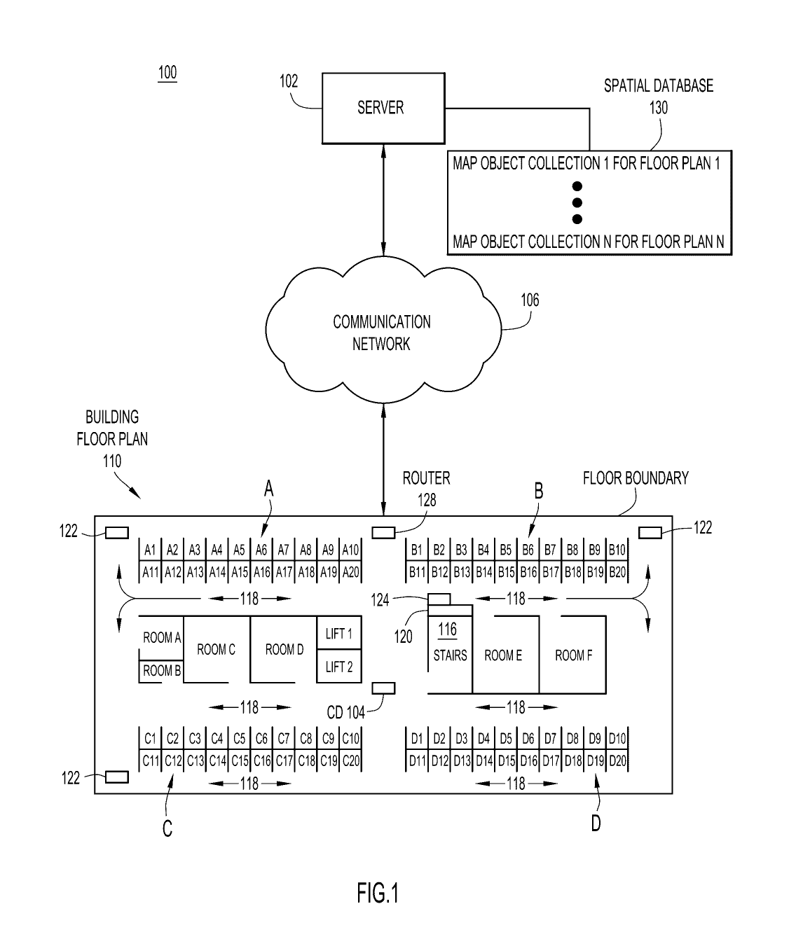

Referring first to FIG. 1, there is shown a block diagram of an example dynamic mapping environment 100 in which embodiments directed to mapping of dynamic spaces or areas, such as floor plans, may be implemented. Environment 100 includes a mapping server device 102 (referred to as a server 102) and a client device (CD) 104 that each communicates with a communication network 106 (and thus each other) over wired and/or wireless connections/links with the communication network. Communication network 106 may include one or more local area networks (LANs) and one or more wide area networks (WANs), such as the Internet. Also shown in FIG. 1 is an overhead view or real-world floor plan 110 (referred to simply as a “floor plan 110”) of a floor in a building (not specifically shown in FIG. 1) on which client device 104 is located. Floor plan 110 includes a variety of different real-world floor plan physical/actual objects, including groups of work cubicles A-D, rooms A-F, lifts 1 and 2, stairs 116, passageways 118 traversable by a person (depicted in FIG. 1 as rectangular-shaped clear spaces surrounding the aforementioned objects), an object 120 in one of the passageways, and many other objects not specifically shown in FIG. 1 for purposes of clarity, such as desks, computers, trash cans, printers, chairs, people, and the like.

Floor plan 110 may include radio frequency (RF) transmitters 122, positioned at predetermined spaced-apart locations around floor plan 110, to transmit respective RF signals throughout the floor plan. One or more location sensors (e.g., location sensor 124) affixed to, or otherwise associated with, the floor plan physical objects (e.g., object 120) may estimate their respective locations on floor plan 110 based on the RF signals, and transmit their locations (and thus the locations of their associated objects) throughout the floor plan. Techniques to estimate sensor location may include RF trilateration and RF triangulation. RF trilateration uses estimated ranges from multiple receivers to estimate the location of a sensor, while RF triangulation uses the angles at which the RF signals arrive at multiple receivers to estimate the location of a sensor. The sensors may include RF identifier (ID) tags, and the like. Communication devices on floor plan 110, e.g., client device 104 and the sensors, may communicate with communication network 106 via a router device 128 on floor plan 110.

FIG. 1 presents environment 100 by way of example only, and it is understood that a dynamic mapping environment may include any number of real-world building floor plans and client devices operating in the floor plans with respective connections to server 102 through communication network 106. Thus, server 102 generates and stores a dynamic spatial database 130 representative of multiple (building) floor plans 1-N. Spatial database 130 includes data object collections 1-N each for a corresponding one of floor plans 1-N. Each data object collection i includes graphics renderable data objects that define respective physical objects of corresponding floor plan i, including, e.g., a floor plan perimeter or outer boundary, rooms, connected pathways traversable by a person, and movable objects. The data objects of a given object collection i may be rendered individually and independently of each other into a displayable map of the corresponding floor plan i and, therefore, the data objects are also referred to as “map objects.”

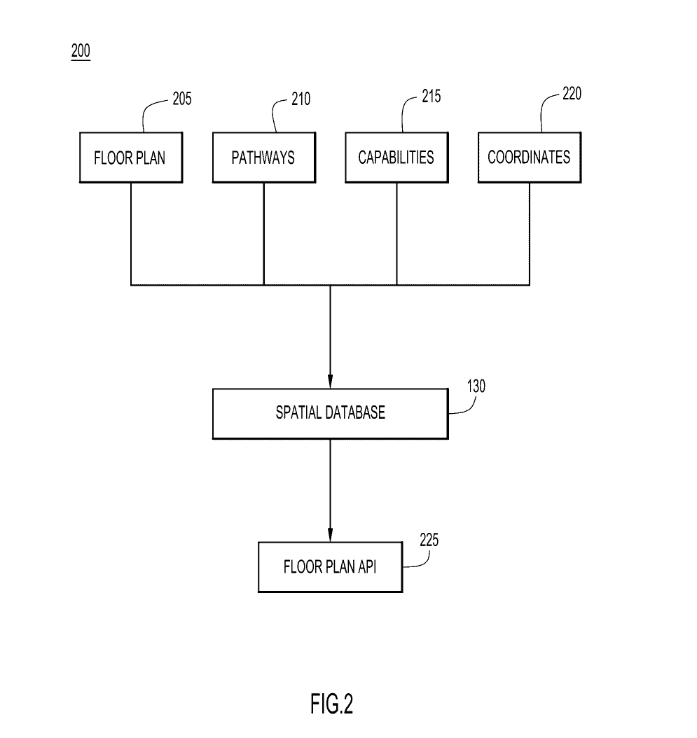

With reference to FIG. 2, there is a flowchart of an example method 200 of generating map object entries in spatial database 130 performed by server 102.

At 205, an electronic/pictorial version (i.e., representation) of a floor plan (e.g., real-world floor plan 110) is received, such as a PDF version of the floor plan. The received version of the floor plan may be processed to retrieve metadata and geometry (i.e., shapes and dimensions thereof) that effectively makeup the floor plan, and the metadata is stored to spatial database 130. The metadata may include: object shapes and their dimensions; object type indicators, such as pathways, rooms, and cubicles; object location, such as latitude and longitude; and various object properties and tags.

At 210, information relating to pathways is received and also stored to spatial database 130. The pathway information identifies areas of the floor plan that may be walked through, i.e., that are traversable by a person.

At 215, information relating to capabilities provided by or associated with the physical objects of the floor plan may be received and stored in the metadata of spatial database 130. Examples of capabilities include, but are not limited to, lighting information, heating, ventilation, and air conditioning (HVAC) information, collaboration equipment, and the like.

At 220, locations, e.g., location coordinates, of physical objects of the floor plan, including locations for people, places, or things, may be received from a variety of sources and stored in the metadata of spatial data base 130. The locations may be received as inputs to server 102 by an administrator or from an electronic file, received from client device 104, or from sensors and RF ID tags, such as location sensor 124.

The various data received at 205-220 may be periodically updated over time in order to update spatial database 130 over time.

At 225, a floor plan application programming interface (API) on server 102 receives queries from client devices (e.g., client device 104) for the information in spatial database 130 and, in response to the queries, retrieves the information from the spatial database, and transmits the retrieved information to the requesting client devices.

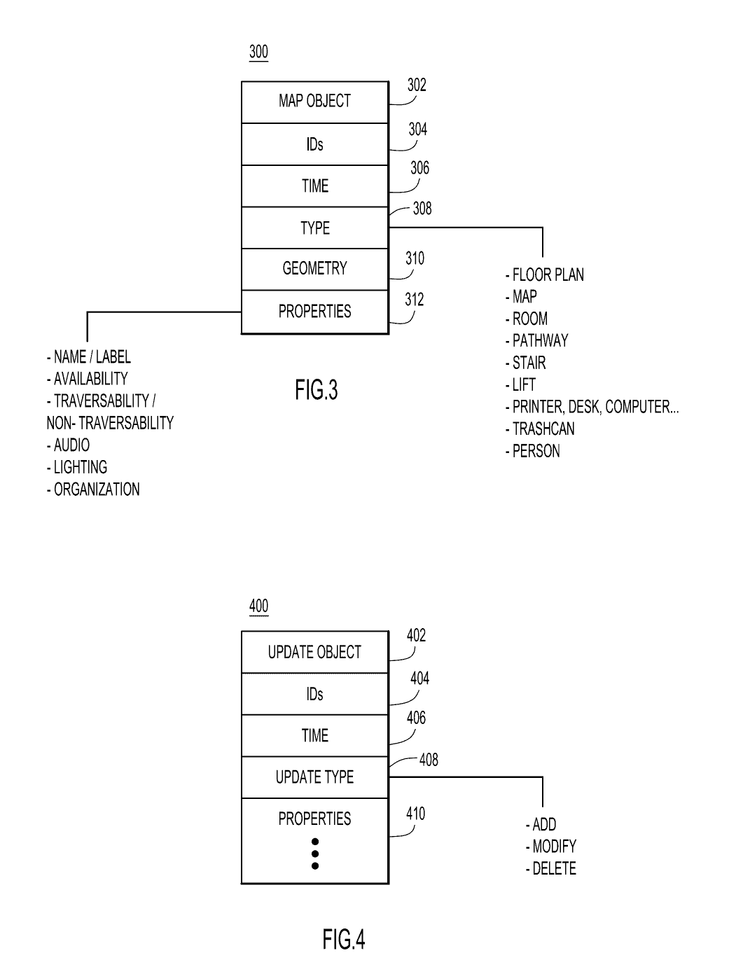

With reference to FIG. 3, there is an illustration of a generalized format of an example vector graphics renderable map object 300 created based on method 200 and stored in spatial database 130. Map object 300 defines a corresponding floor plan object. Map object 300 may be rendered on a map of a floor plan into a graphical representation of the physical object defined by the information in the map object. Map object 300 includes: a map object header 302; one or more unique IDs 304 of the map object; a time 306 when the map object was created; a type 308 to indicate a type of physical object defined by the map object, as listed in FIG. 3; a geometry 310 of the physical object defined by the map object, including a shape (e.g., polygon), and boundary coordinates of the shape that represent dimensions of the shape; and properties 312 of the physical object defined by the map object. In embodiments described below, server 102 may retrieve map object 300 from spatial database 130 and transmit a map object message including the retrieved map object to a requesting client device, such as client device 104. Thus, map object 300 also represents the aforementioned map object message.

With reference to FIG. 4, there is an illustration of a generalized format of an example map object update 400 created and stored in spatial database 130 responsive to update information provided at operations 205-220, as described above. Map object update 400 defines a change with respect to a map object and the corresponding physical object of a floor plan. Map object update 400 may be rendered on a map of a floor plan into a graphical representation of the change defined by the information in the map object update. Map object update 400 includes: a map object update identifier 402; one or more IDs 404 to identify a map object to which the map object update pertains; a time 406 that the update was created or occurred; an update type 408 defining the type of map update, e.g., whether the map object update is to add a new map object corresponding to a new physical object on a floor plan, modify an existing map object corresponding to an existing physical object on the floor plan, or delete an existing map object corresponding to an existing object on the floor plan; and properties 410 as listed above for map object properties 312. In embodiments described below, server 102 may retrieve map object update 300 from spatial database 130 or otherwise create the map object update and transmit a map object update message including the retrieved map object update to a requesting client device, such as client device 104. In such an update message, update type 408 represents an instruction to client device 104 to modify, delete, or add the identified map object.

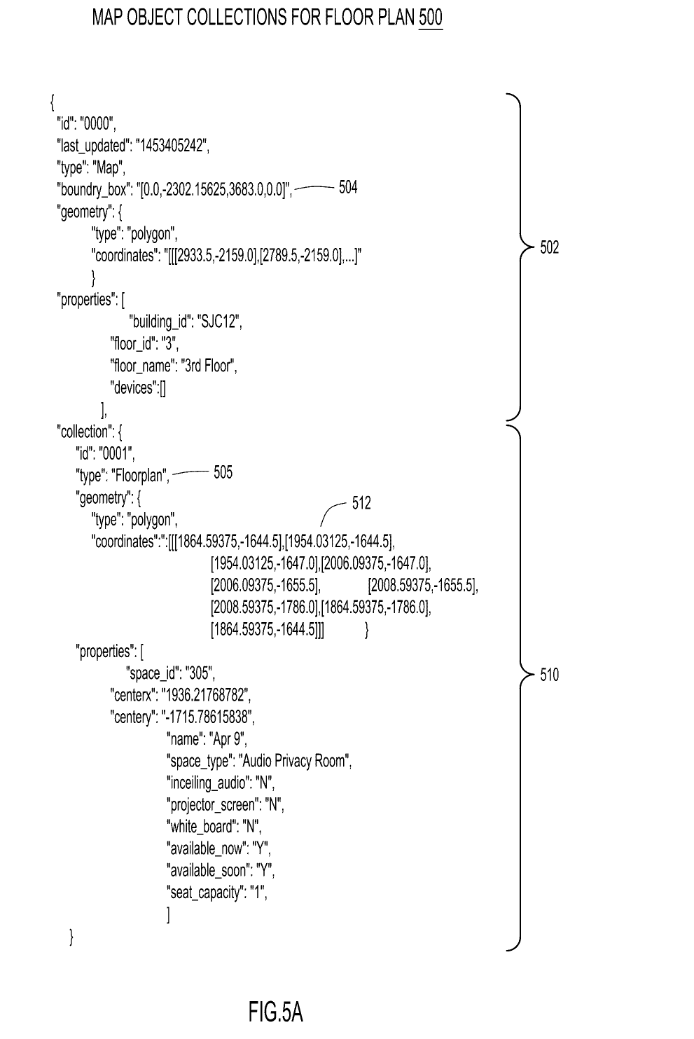

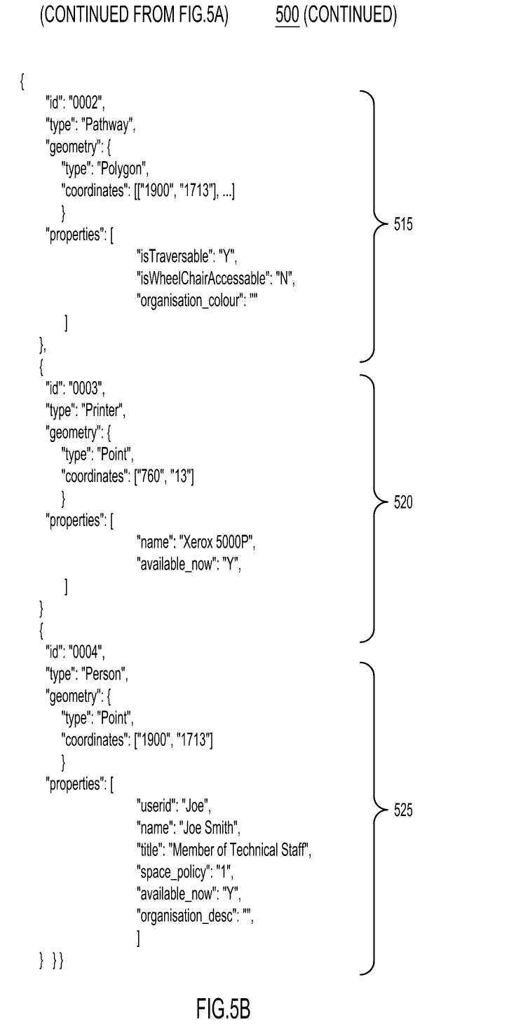

With reference to FIGS. 5A and 5B, there is an example collection 500 of map objects that collectively define a map of a building floor plan, and that may each be rendered individually and independently of other map objects into a graphic on the map. Object map collection 500 includes a high-level map object 502 with ID 0000 that defines a map outer boundary 504. The map defined by map object 502 represents a building having a building ID SJC12. Map outer boundary 504 defines an outer perimeter of a room. Object map collection 500 also includes a map object 510 with ID 0001 that defines a floor plan of the map. Floor plan map object 510 includes coordinates 512 that define the spatial extent or dimensions of the floor plan. Object map collection 500 further includes: a map object 515 with an ID 0002 that defines a traversable pathway on the floor plan; a map object 520 with ID 0003 that defines a printer on the floor plan; and a map object 525 with ID 0004 that defines a person on the floor plan. Map objects 502, 510, 515, 520, and 525 may be stored in spatial database 130, retrieved from the spatial database, and transmitted to client device 104 for rendering into the map and displayed at the client device.

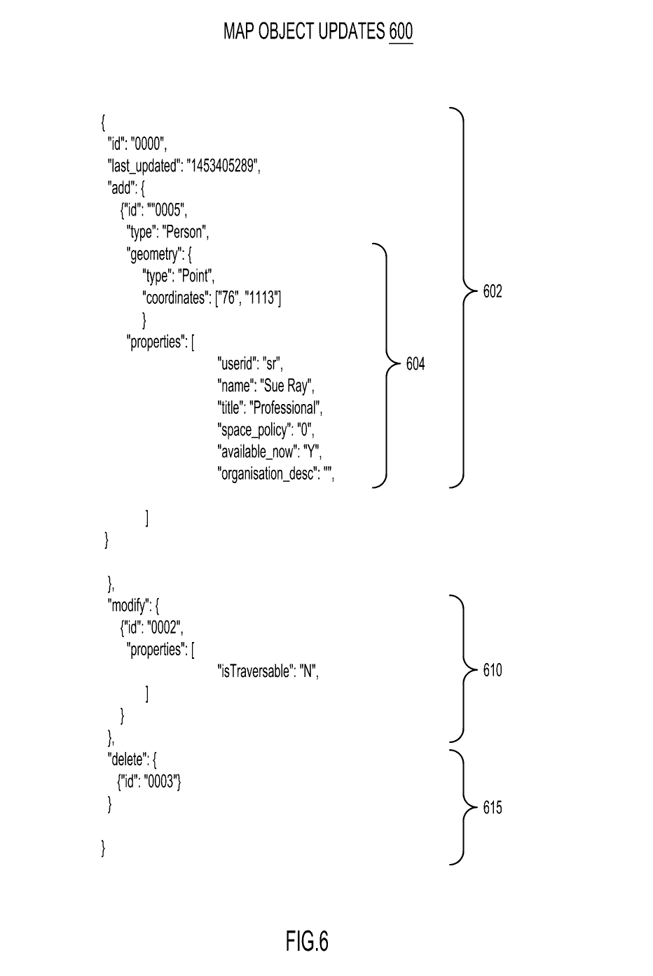

With reference to FIG. 6, there is an example collection of map object updates 600 that may represent changes to the floor plan (and map thereof) defined by map object collection 500. Map object updates 600 include a map object update 602 with ID 0000 to add a person to the floor plan. Map object update 602 includes map object information 604 defining the geometry, location, and properties of the person to be added. Map object updates 600 also include a map object update 610 with ID 0002 to modify the pathway defined by map object 515. Map object update 610 changes the pathway from traversable to non-traversable, indicating a person cannot walk through the pathway, i.e., that the pathway is blocked. Map object updates 600 also include a map object update 615 with ID 0003 to delete the printer defined by map object 520 from the floor plan.

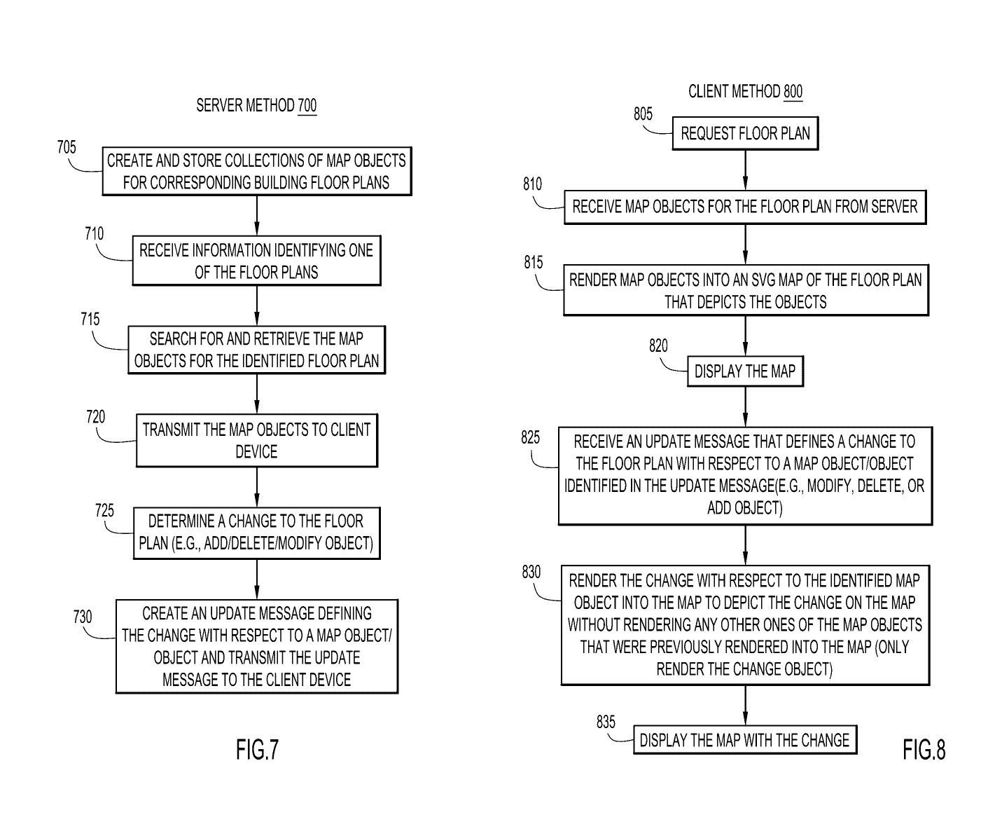

Various methods of mapping a dynamic floor plan and way finding related to the mapping performed by server 102 and client device 104 are now described in connection with FIGS. 7-14.

With reference to FIG. 7, there is a flowchart of an example method of dynamic floor plan mapping 700 performed by server 102.

At 705, server 102 creates and stores collections 1-N of map objects for corresponding building floor plans 1-N in spatial database 130. Each collection i includes map objects defining respective physical objects of the corresponding floor plan, including, but not limited to a floor plan perimeter or outer boundary, rooms, pathways traversable by a person, movable and/or reconfigurable objects, people, and so on. The pathways (defined by corresponding map objects) are connectable with each other to form paths around the various other physical objects defined by the map objects. Each map object defines a location for the respective physical object on the corresponding floor plan.

At 710, server 102 receives a request including information identifying one of floor plans 1-N, such a map object collection ID, floor plan name, building name, and the like. The request may be transmitted from client device 102 to server 102 over a communication link established between the server and the client device, or input to the server by an administrator, for example.

At 715, server 102 searches spatial database 130 for a floor plan based on the identifying information and, when the identified floor plan is found, retrieves the map objects from the corresponding map object collection.

At 720, server 102 transmits the retrieved map objects to a source of the request, e.g., client device 102, over the communication link.

At 725, server 102 may determine that a change to the floor plan has occurred due to floor plan update information received by the server, as described above. The change may represent an addition of a new physical object to the floor plan, a modification to an existing physical object on the floor plan, or a deletion of an existing physical object from the floor plan.

At 730, responsive to the determined change, server 102 creates a map object update message defining the change with respect to a map object that represents the change, and transmits the update message to client device 104 over the communication link. For example, the update message may include an instruction to add a new map object corresponding to a new object to the floor plan, modify an existing map object corresponding to an existing physical object on the floor plan, or delete an existing map object corresponding to an existing physical object on the floor plan. For example, server 102 may determine that a moveable object has changed its initial position on the floor plan and thus moved to a new position, in which case the update message includes (i) an instruction to modify the existing map object corresponding to the moved object, and (ii) the new position.

Server 102 repeats method 700 over time for each new floor plan request and update received and determined by the server.

With reference to FIG. 8, there is a flowchart of an example method of dynamic floor plan mapping 800 performed by client device 104 corresponding to method 700.

At 805, client device 104 requests a floor plan, e.g., transmits a request for a floor plan, including floor plan identifying information, to server 102 over a communication link established between the client device and the server.

At 810, client device 104 receives map objects for the requested floor plan and that were transmitted by server 102 over the communication link.

At 815, client device 104 renders the (received) map objects into a map of the floor plan that depicts the physical objects. In an example, client device performs separate or individual spatial vector graphics (SVG) rendering of each map object to produce the map as an SVG map on a pixel grid in which each object is represented as a pixel area. That is, each map object is rendered as a vector graphic into the vector graphic map, which is different from conventional use of an image overlay on a background image to show the objects. Other rendering techniques besides SVG may be used. The rendered map may be stored in a display memory of client device 104.

At 820, client device 104 displays the map on a display of the client device.

At 825, client device 104 receives an update message from server 104 over the communication link that defines a change to the floor plan with respect to a map object (corresponding to a physical object) identified in the update message. The update message may include an instruction to modify, delete, or add a map object/object to the floor plan.

At 830, client device 104 SVG renders the change with respect to the identified map object into the map to depict the change on the map, without rendering any other ones of the map objects that were previously rendered into the map. This limited rendering reduces computational complexity in client device 104 and thus saves time.

At 835, client device 104 displays the map with the change rendered thereon.

With reference to FIG. 9, there is an illustration of a partially rendered floor plan map 900 corresponding to real-world floor plan 110 that may be displayed by client device 104 during method 800. Most of the map objects defining the physical objects of floor plan 110 have been rendered into map 900 as corresponding graphics objects, except for map objects defining pathways 118 and object 120. For example, map 900 shows cubicle groups 902(A)-902(D) corresponding to cubicles A-D, and also depicts the rooms, the lifts, and the stairs of floor plan 110. The cross-hatching in areas of map 900 indicates the areas on are non-traversable (since traversable pathways have not yet been rendered).

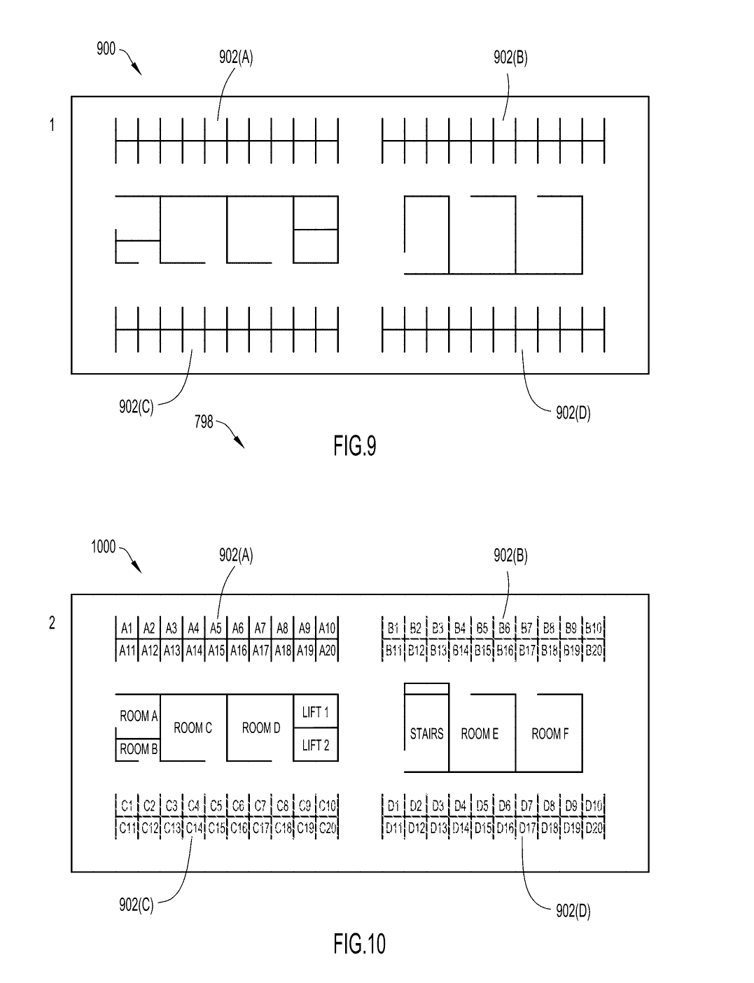

With reference to FIG. 10, there is an illustration of a fully rendered floor plan map 1000 corresponding to floor plan 110 that may be displayed by client device 104. The map objects defining pathways 118 and an object corresponding to object 120 of real-world floor plan 110 have been rendered into map 1000 as corresponding graphics objects. Pathways are rendered as inter-connected clear or transparent rectangle areas surrounding the other objects rendered into the map, i.e., the cross-hatching in corresponding areas of map 900 has been replaced with transparency in map 1000. Also, labels/names defined in map objects have also been added to the corresponding graphics objects on map 1000; however transmitters 122 and sensor 124 have not been rendered into map 1000 in the example shown.

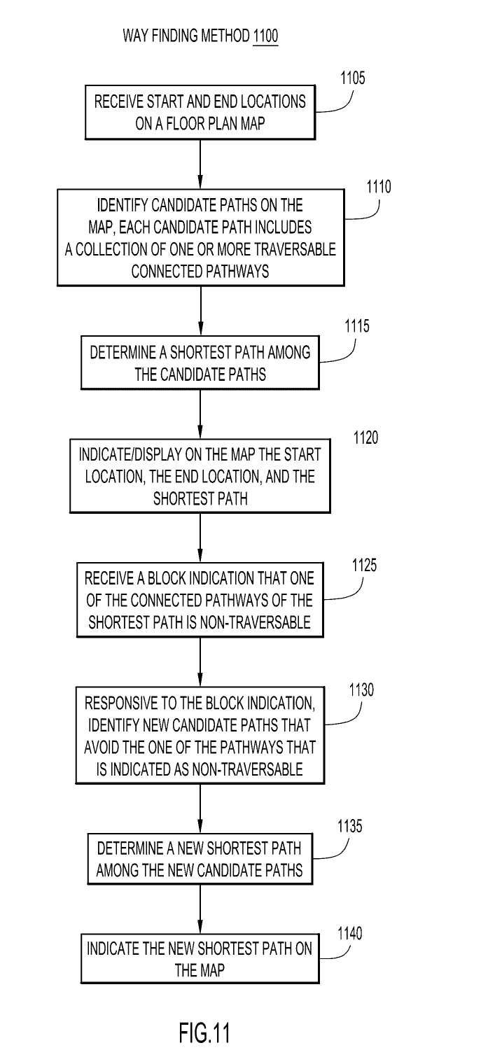

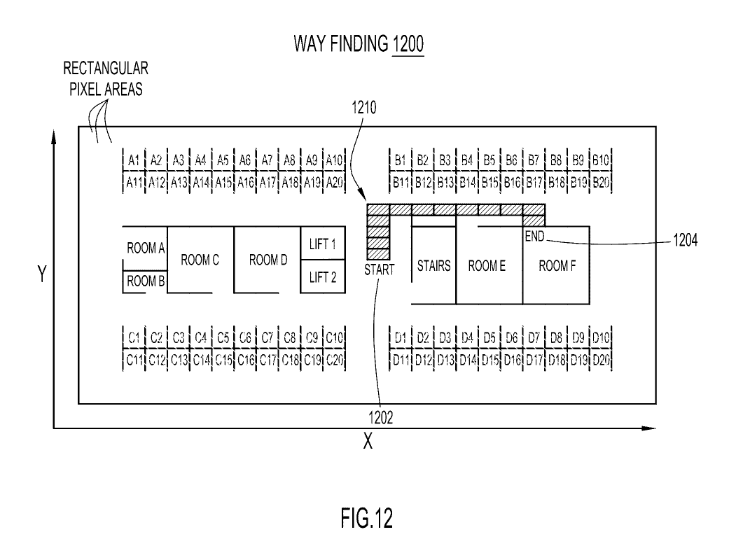

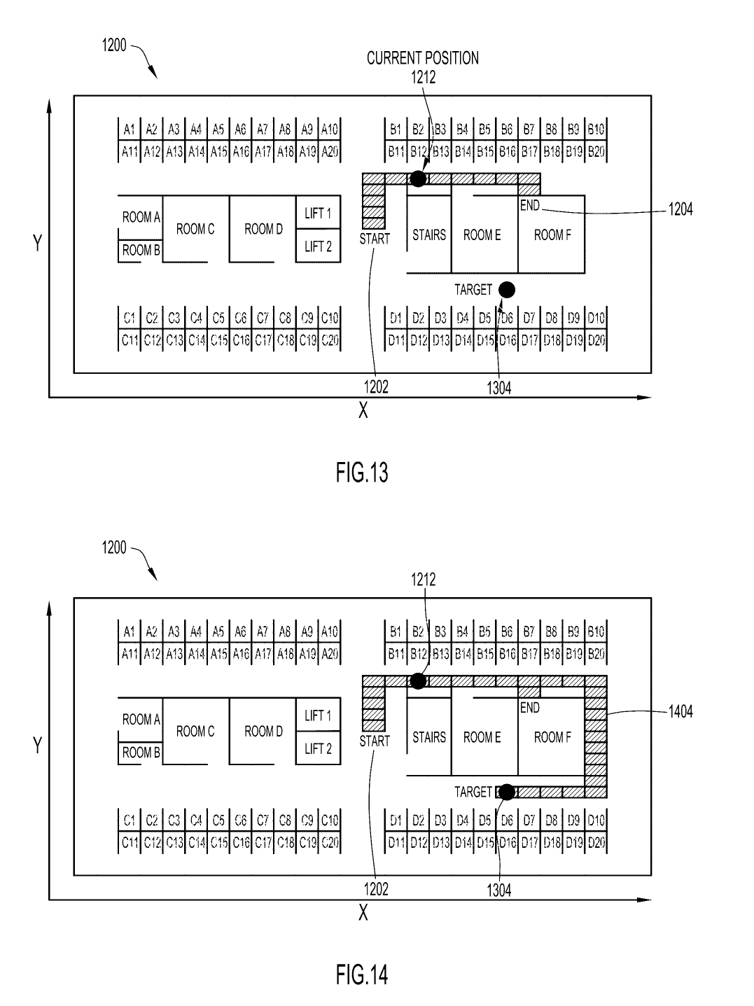

With reference to FIG. 11, there is a flowchart of an example method 1100 of way finding on a previously rendered and displayed floor plan map performed by/on client device 104. Way finding includes determining and optionally indicating a route from a first location to a second location on the map. Method 1100 is described also with reference to FIGS. 12-14. FIG. 12 is an illustration of an example rendered floor plan map 1200 of floor plan 110 created by client device 104 (in method 700) and that shows a shortest path between end and start locations on the map. FIG. 13 is an illustration of floor plan map 1200 that shows a current location/position of client device 104 as the client device moves along the shortest path. FIG. 14 is an illustration of floor plan map 1200 that shows a new shortest path between a new end location on the map and a current location of the client device on the map.

At 1105, client device 104 receives a start location and an end location on the real-world floor plan that correspond to a start location and an end location on the map of the floor plan. The received locations may be entered into client device 104 by a user of the client device, for example. Client device 104 may translate the start and end real-world locations into start and end map location using any known or hereafter developed technique to translate real-world locations to rendered map locations. For example, in FIG. 12, the received start and end real-world locations are translated by client device 104 into a start location 1202 and an end location 1204 shown on map 1200.

At 1110, client device 104 identifies candidate paths on the map between the start location on the map and the end location on the map. Each candidate path includes a respective collection of one or more of the connected pathways that together lead from the start location to the end location on the map.

At 1115, client device 104 determines a shortest path among the candidate paths. The determined shortest path represents a routing decision made by client device 104. In an example in which client device 104 renders each map object that defines a pathway into the map as a collection of transparent pixel areas (i.e., areas of pixels on a display) that collectively represent the pathway, client device 104 determines as the shortest path the one of the candidate paths represented by a fewest number of pixel areas in the collection of connected pathways that are to be traversed between the start location and the end location on the map.

At 1120, client device 104 indicates on the map (i.e., displays) the start location, the end location, and the determined shortest path. For example, in FIG. 12, map 1200 indicates a shortest path 1210 between start location 1202 and end location 1204.

Also, client device 104 may (i) track over time a current location of the client device on the real-world floor plan while a user carrying the client device moves from the start location to the end location on the floor plan along the real-world shortest path corresponding to the shortest path shown on map 1200, (ii) translate the current location to coordinates on the map, and (iii) indicate the translated location as a current location on the map (i.e., a current map location). In this way, a user of client device 104 may conveniently view the current location while the user follows the shortest path toward the end location. For example, in FIG. 13, map 1200 shows a tracked current location/position 1212 of client device 104 on shortest path 1210.

At 1125, client device 104 may, in a first circumstance, receive a block indication that one of the connected pathways of the determined shortest path is non-traversable, e.g., the client device may receive an update message indicating that the one of the connected pathways has changed its status from traversable to non-traversable, or that a new object obstructs that pathway.

Alternatively, in a second circumstance, the end location may be blocked or become otherwise inaccessible, in which case client device 104 may (i) receive a new end location on the floor plan, e.g., the user may enter the new end location for the floor plan or the new end location may be transmitted to the client device by server 102, (ii) translate the new end location on the floor plan to a new end location on the map, and (iii) indicate the new end location on the map. For example, for the second circumstance, in FIG. 13, map 1200 indicates such a new end location 1304 or “target” received by client device 104.

At 1130, assuming the first circumstance mentioned above, client device 104 identifies new candidate paths that avoid the one of the pathways that is non-traversable and lead from the current location to the end location. On the other hand, assuming the second circumstance mentioned above, client device 104 identifies new candidate paths that lead from the current location to the new end location. Thus, in both circumstances, the current location on the map becomes a new start location on the map for purposes of way finding.

At 1135, client device 104 determines a new shortest path among the new candidate paths.

At 1140, client device 104 indicates the new shortest path on the map. For example, assuming the second circumstance, in FIG. 14, map 1200 shows a new shortest path 1404 from current location 1212 to new end location 1304.

As described above in connection with method 1100, a given routing decision by client device 104 may be influenced dynamically by subsequent events. Such events may include, but not be limited to, people moving, the availability of space (e.g., rooms) changing, or perhaps movement of moveable objects, such as robots, trash cans, desks, and so on. The events cause the objects being rendered on the map to change. The changes may be provided to client device 104 dynamically and rendered by the client device into the map. Events indicating that an object referenced in a waypoint (e.g., in a pathway or an object connected with the pathway) has changed trigger a repeat of the operations of method 1100 as necessary to determine new shortest paths until client device 104 is within a predetermined distance of the end location (or new end location).

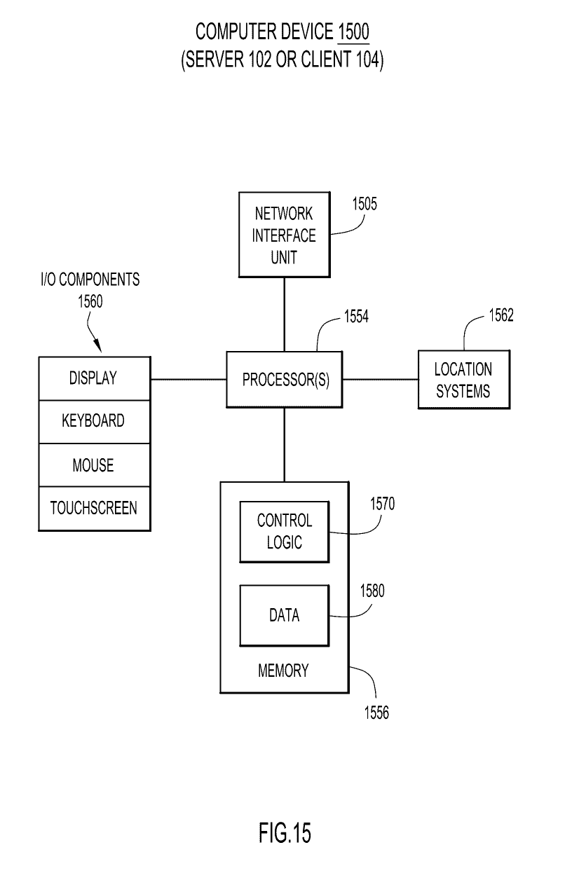

With reference to FIG. 15, there is a block diagram of a computer device or system 1500 representative of server 102 and client device 104. Computer device 1500 includes a network interface unit 1505 to communicate with a network, a processor 1554 (or multiple processors), and memory 1556. Network interface unit 1505 may support wired or wireless connections with the network, and may include an Ethernet card, for example. The memory 1556 stores instructions for implementing server methods or client device methods described herein. Computer device 1500 also includes input/output (I/O) components 1560 connected with processor 1554 including a display for displaying information, and input components, such as a keyboard, mouse, touchscreen, and the like, through which a user may enter information into the computer device. Computer device 1500 may also include one or more location systems 1562, such as a Global Positioning System (GPS) or other location device for determining a location of the computer device.

The memory 1556 may comprise read only memory (ROM), random access memory (RAM), magnetic disk storage media devices, optical storage media devices, flash memory devices, electrical, optical, or other physical/tangible (non-transitory) memory storage devices. The processor 1554 is, for example, a microprocessor or a microcontroller that executes instructions stored in memory. Thus, in general, the memory 1556 may comprise one or more tangible computer readable storage media (e.g., a memory device) encoded with software comprising computer executable instructions and when the software is executed (by the processor 1554) it is operable to perform the operations described herein. Memory 1556 stores control logic 1570 to perform the server methods or the client methods described herein if computer device 1500 represents server 102 or client device 104, respectively. The memory may also store data 1580 used and generated by control logic 1570 as described herein.

In summary, conventional approaches for indoor maps use overlays of images placed on a world map. So, the map of a floor plan or venue is relegated to a set of pixels being placed on an existing mapping solution. Accordingly, embodiments described above introduce novel data- and event-driven methods and apparatuses for building dynamic spatial storage for people, places, and things that provide an up-to-date, relevant, and improved user experience. The embodiments apply data and event driven approaches for collecting multiple types of data, building a scalable vector graphic from the types of data, and providing a dynamic floor plan where the objects may be readily added and removed. All object data (e.g., pathways, rooms, people, and other things) located within a boundary of a coordinate area may represent dynamic objects that can, and do, interact with each other. As the objects change, a client device rendering maps based on the object data updates the object changes on the map individually as vector graphics. This allows the maps, such as indoor maps, to be updated so that they reflect a dynamically changing object environment.

The embodiments include storing and dynamically updating different types of objects, such as a name, a type, latitude, longitude, and/or XY coordinates, and producing the shape of an object and a description of all of possible paths between locations on a floor plan. The embodiments advantageously provide an innovative method of rendering and representing indoor maps, particularly in venues where location navigation is needed, to provide a new and better customer/user experience. Connected to a map, the embodiments allow for people, places, and things to be viewed in a coordinate area. By avoiding conventional approaches that disadvantageously incorporate pathways and geographic information into tiles, and apply overlays, embodiments herein create a far more dynamic experience because the embodiments take into consideration that every object in a map can change, including the layout of room, and render such changes individually into the map. The embodiments allow for a better understanding of a mapped environment and its availability and capabilities, which, in turn, enables a better utilization of the space and increases user productivity.

As mentioned above, the embodiments apply a data driven approach for collecting multiple types of data that render the floor plan into a scalable vector graphic. Mapped objects are stored and updated into the map and are rendered together for the area being represented. That will allow objects to be added and removed easy and provide a dynamic and still adequate floor plan for accurate routing techniques. This allows a better user experience since the information will be immediately updated and relevant. An example use case includes a conference event held in a convention center or a multi-use building. The event often utilizes spaces that may be reconfigured. Walls in these venues can change throughout the event. While a keynote may utilize an entire space, the following breakouts could partition a room into distinct areas. In addition, doors could be closed due to the positioning of cameras or managing of traffic flows. All of these changes have an impact on how a map of the floor spaces (venue floor plan) is rendered and the pathways on the map. By combining all of these objects into a coordinate area, the map and possible pathways can be dynamically updated as the event occurs. In addition, client devices may receive updates and render changes relatively immediately.

In summary, in one form, a method is provided comprising: at a client device: receiving map objects that define respective physical objects of a floor plan of a building, including a floor plan outer boundary, one or more rooms, and connected pathways traversable by a person; rendering, in scalable vector graphic form, the map objects into a map of the floor plan that depicts the respective physical objects, including the one or more rooms, the connected pathways, and the outer boundary; displaying the map; receiving an update message that defines a change to the floor plan with respect to a map object identified in the update message; rendering the change with respect to the identified map object into the map to depict the change on the map without rendering any other ones of the map objects that were previously rendered into the map; and displaying the map with the change depicted on the map.

In another form, an apparatus is provided comprising: a network interface to communicate with a network; a display; and a processor coupled with the network interface and the display and configured to: receive map objects that define respective physical objects of a floor plan of a building, including a floor plan outer boundary, one or more rooms, and connected pathways traversable by a person; render, in scalable vector graphic form, the map objects into a map of the floor plan that depicts the respective physical objects, including the one or more rooms, the connected pathways, and the outer boundary; cause display of the map; receive an update message that defines a change to the floor plan with respect to a map object identified in the update message; render the change with respect to the identified map object into the map to depict the change on the map without rendering any other ones of the map objects that were previously rendered into the map; and cause display of the map with the change depicted on the map.

In yet another form a method is provided comprising: at a server: storing information for collections of map objects for corresponding floor plans, each collection including map objects defining respective physical objects of the corresponding floor plan, including a floor plan outer boundary, one or more rooms, connected pathways traversable by a person, and movable objects, each map object defining a location for the respective physical object on the corresponding floor plan; receiving information identifying one of the floor plans; retrieving the collection of map objects for the identified floor plan; establishing a communication link with a client device; transmitting the retrieved collection of map objects to the client device over the communication link; determining that a change to the floor plan has occurred; and transmitting to the client device over the communication link an update message indicating the change to the floor plan.

In summary, in yet another form, a non-transitory processor readable medium is provided. The processor readable medium stores instructions that, when executed by a processor, cause the processor to perform each of the methods described herein.

The above description is intended by way of example only. Various modifications and structural changes may be made therein without departing from the scope of the concepts described herein and within the scope and range of equivalents of the claims.

What is claimed is:

1. A method comprising:
at a client device:
receiving map objects that define respective physical objects of a floor plan of a building, the floor plan including a floor plan outer boundary, one or more rooms, and connected pathways;
rendering, in scalable vector graphic form, the map objects into a map of the floor plan that depicts the respective physical objects, including the one or more rooms, the connected pathways, and the outer boundary;
displaying the map;
receiving an update message that defines a change to the floor plan with respect to a map object identified in the update message;
rendering the change with respect to the identified map object into the map to depict the change on the map without rendering any other map objects that were previously rendered into the map; and
displaying the map with the change depicted on the map.

2. The method of claim 1, wherein:
the update message includes an instruction to modify, delete, or add the identified map object; and
the rendering the change includes performing a rendering operation to modify, delete, or add the identified map object in accordance with the instruction.

3. The method of claim 1, wherein the map objects and the update message are received over a wireless communication link.

4. The method of claim 1, further comprising:
receiving a start location on the floor plan corresponding to a start location on the map, and an end location on the floor plan corresponding to an end location on the map;
identifying candidate paths on the map between the start location on the map and the end location on the map, wherein each candidate path includes a respective collection of one or more of the connected pathways;
determining a shortest path among the candidate paths; and
indicating on the map the start location, the end location, and the shortest path.

5. The method of claim 4, wherein the start location on the floor plan corresponds to a location of the client device on the floor plan of the building.

6. The method of claim 4, further comprising:
after the displaying the indication of the shortest path on the map, receiving a block indication that one of the connected pathways of the shortest path is non-traversable;
responsive to the block indication, identifying new candidate paths that avoid the one of the pathways that is indicated as non-traversable;
determining a new shortest path among the new candidate paths; and
indicating the new shortest path on the map.

7. The method of claim 6, wherein:
the receiving the block indication includes receiving a message that includes an indicator that the one of the connected pathways is non-traversable.

8. The method of claim 6, wherein:
the receiving the block indication includes receiving a new map object that defines a physical object located in the one of the connected pathways of the shortest path; and
rendering the new map object into the map without rendering the one of the map objects that defines the one of the connected pathways.

9. The method of claim 4, wherein:
the rendering includes representing each of the pathways as pixel areas on a display; and
the determining includes determining as the shortest path the one of the candidate paths represented by a fewest number of pixel areas that are to be traversed between the start location and the end location.

10. The method of claim 1, wherein each map object includes data that defines for the respective physical object:
a shape and coordinates that represent shape dimensions;
a type, including one of an outer boundary, a room, or a pathway; and
location coordinates of the physical object on the floor plan.

11. An apparatus comprising:
a network interface to communicate with a network;
a display; and
a processor coupled with the network interface and the display and configured to:
receive map objects that define respective physical objects of a floor plan of a building, the floor plan including a floor plan outer boundary, one or more rooms, and connected pathways;
render, in scalable vector graphic form, the map objects into a map of the floor plan that depicts the respective physical objects, including the one or more rooms, the connected pathways, and the outer boundary;
cause display of the map;
receive an update message that defines a change to the floor plan with respect to a map object identified in the update message;
render the change with respect to the identified map object into the map to depict the change on the map without rendering any other ones of the map objects that were previously rendered into the map; and
cause display of the map with the change depicted on the map.

12. The apparatus of claim 11, wherein:
the update message includes an instruction to modify, delete, or add the identified map object; and
the processor is configured to render the change by performing a rendering operation to modify, delete, or add the identified map object in accordance with the instruction.

13. The apparatus of claim 11, wherein the processor is further configured to:
receive a start location on the floor plan corresponding to a start location on the map, and an end location on the floor plan corresponding to an end location on the map;
identify candidate paths on the map between the start location on the map and the end location on the map, wherein each candidate path includes a respective collection of one or more of the connected pathways;
determine a shortest path among the candidate paths; and
cause display on the map of the start location, the end location, and the shortest path.

14. The apparatus of claim 13, wherein the processor is further configured to:
after the shortest path is displayed on the map, receive a block indication that one of the connected pathways of the shortest path is non-traversable;
responsive to the block indication, identify new candidate paths that avoid the one of the pathways that is indicated as non-traversable;
determine a new shortest path among the new candidate paths; and
cause display of the new shortest path on the map.

15. The apparatus of claim 13, wherein:
the processor is configured to render by representing each of the pathways as pixel areas on a display; and
the processor is configured to determine as the shortest path the one of the candidate paths represented by a fewest number of pixel areas that are to be traversed between the start location and the end location.

16. The apparatus of claim 11, wherein each map object includes data that defines for the respective object:
an object shape and coordinates that represent object shape dimensions;
an object type, including one of an outer boundary, a room, or a pathway; and
location coordinates of the physical object on the floor plan.

17. A method comprising:
at a server:
storing information for collections of map objects for corresponding floor plans, each collection including map objects defining respective physical objects of the corresponding floor plan, including a floor plan outer boundary, one or more rooms, connected pathways traversable by a person, and movable objects, each map object defining a location for the respective physical object on the corresponding floor plan;
receiving information identifying one of the floor plans;
retrieving the collection of map objects for the identified floor plan;
establishing a communication link with a client device;
transmitting the retrieved collection of map objects to the client device over the communication link;
determining that a change to the floor plan has occurred; and
transmitting to the client device over the communication link an update message indicating the change to the floor plan.

18. The method of claim 17, wherein each map object includes data that defines for the respective physical object:
a shape and coordinates that represent shape dimensions;
a type, including one of an outer boundary, a room, or a pathway; and
location coordinates of the physical object on the floor plan.

19. The method of claim 17, wherein:
the determining includes determining the change to the floor plan as a modification, a deletion, or an addition with respect to an identified physical object; and
the transmitting includes transmitting the update message with an instruction to modify, delete, or add with respect to the identified physical object according to the determining.

20. The method of claim 19, wherein:
the determining further includes determining the change as a changed position of one of the movable objects on the floor plan.

21. The method of claim 19, wherein:
the determining further includes receiving a message from a location sensor associated with the one of the movable objects indicating the changed position thereof.

22. The method of claim 19, further comprising, at the client device:
receiving the map objects transmitted by the server;
rendering, in scalable vector graphic form, the received map objects into a map of the floor plan that depicts the respective physical objects at the locations thereof;
displaying the map;
receiving the update message transmitted by the sever device;
responsive to the update message, only rendering the change indicated in the update message into the map to depict the change on the map; and
displaying the map with the depicted change.

23. The method of claim 22, wherein, at the client device:
the receiving includes receiving the update message with the instruction to modify, delete, or add with respect to the identified physical object; and
the only rendering includes only performing a rendering operation to modify, delete, or add according to the instruction.
